(19) United States
(12) Patent Application Publication
(10) Pub. No.: US 2016/0157608 A1
(43) Pub. Date: Jun. 9, 2016

(54) METHOD OF MANUFACTURING A FELT GLIDE WITH SLIDER ROUNDED EDGES

(71) Applicant: GERGONNE SAS, Oyonnax (FR)

(72) Inventors: Charles GERGONNE, Oyonnax (FR); Bertrand GERGONNE, Oyonnax (FR)

(73) Assignee: GERGONNE SAS, Oyonnax (FR)

(21) Appl. No.: 14/904,824

(22) PCT Filed: May 21, 2014
(86) PCT No.: PCT/FR2014/051187

§ 371 Date: Jan. 13, 2016

(30) Foreign Application Priority Data
Jul. 18, 2013 (FR) 13/57055

(51) Int. Cl. A47B 91/06; B29C 43/52; B29B 11/02; B29C 43/18

(52) U.S. Cl. CPC A47B 91/06; B29C 43/18; B29C 43/52; B29B 11/02; B29K 2027/18

(57) ABSTRACT

The invention concerns a method for manufacturing a slider pad with rounded edges which comprises the following steps:
providing at least one felt element which has:
   a first face covered with an adhesive, said adhesive being coated with a protective layer and
   a second face opposite the first face;
performing in the felt element a plurality of cuttings whose shape is suitable for obtaining a plurality of slider pads which have each a first face covered with the adhesive coated with the protective layer and a second face opposite this first face ;
hot-pressing the second face of each of the slider pads obtained at the cutting step so as to make said second face of each of the slider pads convex.

The present invention concerns a method for manufacturing a slider pad intended to be affixed to the lower face of a relatively heavy object likely to be moved such as a piece of furniture (particularly a chair, an armchair) or the like, in order to facilitate moving of said object by sliding it on a surface such as a floor.

It is already known different embodiments of slider pads which differ from one another in shape, the nature of their materials consisting, on the one hand, of the base intended to be affixed on the piece of furniture, and on the other hand, of the sliding surface intended to be in contact with the floor.

For example, there are slider pads consisting of a base made of a plastic material or an elastomer (for example rubber) covered with a PTFE layer (abbreviation of polytetrafluoroethylene) on the face intended to be in contact with the floor. Generally, the PTFE layer is obtained by injection overmolding. These slider pads have the advantage of having rounded edges which allow them to better pass through the tile joints when moving the piece of furniture on which these pads have been fastened. However, these slider pads have the drawback of being too stiff, due to their base made of plastic or elastomer. This makes them noisy. Furthermore, the manufacturing method of such slider pads is often complicated and requires a significant, costly and complex tool.

It is also known slider pads with straight edges which consist of felt.

In this regard, within the scope of the present invention, felt means a nonwoven fabric made of bristles or fibers. This fabric may consist of natural materials (wool, cellulose) and/or synthetic materials (for example of plastic materials such as polypropylene, polyamide, poly-ethylene terephthalate, or mixtures of these polymers).

These slider pads are generally in the form of felt washers. Their manufacturing is easy, by simply cutting in a material in the form of a plate or a felt material roll. Unlike slider pads having a stiff plastic base, these felt slider pads are not noisy. Indeed, the felt attenuates noise. Furthermore, they avoid scratches of the floor.

Also, another embodiment of slider pad slightly different from felt slider pads consists of covering these felt pads with straight edges with a PTFE layer. Thus, such slider pad has the combined advantages of the felt base (namely less noisy than a base made of a plastic material) and of a good sliding surface due to the PTFE coating layer which increases the sliding of the piece of furniture on the floor relative to a slider pad consisting only of felt. The fact remains that this slider pad, due to its straight edges, has the drawback of risking to cling to the tile joints or to any asperity that a floor may have.

Thus, the felt slider pads, and if necessary the felt slider pads having a PTFE sliding surface are not completely satisfactory, because they risk to cling to the asperities that the floor may have.

Finally, except for the slider pads whose means for fastening to the piece of furniture is an adhesive, the methods for manufacturing slider pads can prove to be complex and costly to implement. For example, when the means for fastening the slider pad to the piece of furniture is a nail, this requires an additional step after the cutting of the slider pads which is generally complex to be performed.

The present invention intends to overcome the detailed above drawbacks known from the slider pads currently on the market. Indeed, the present invention provides a continuous manufacturing method of a slider pad which is economical and perfectly easy to implement. In addition, the slider pad thus obtained by this method has the advantages of not risking to cling to the asperities of the floor (for example at the tile joints), and this with a high-quality sliding and without causing noise.

More specifically, the method for manufacturing a slider pad with rounded edges according to the invention comprises the following steps:
providing at least one felt element which has:
   a first face covered with an adhesive, said adhesive being coated with a protective layer and
   a second face opposite the first face;
performing in the felt element a plurality of cuttings whose shape is suitable for obtaining a plurality of slider pads, which have each a first face covered with the adhesive coated with the protective layer and a second face opposite to this first face;
hot-pressing the second face of each of the slider pads obtained at the cutting step so as to make said second face of each of the slider pads convex.

The adhesive may be selected from acrylic glue, rubber, silicone, polyurethane or even other equivalent glue known to those skilled in the art.

The protective layer may be selected from silicone paper, and silicone films. The silicone films are made of plastic materials such as polypropylene, polyethylene or poly(ethylene terephthalate) which have been coated with silicone.

Preferably, the protective layer is a silicone film made of poly(ethylene terephthalate), since it has the advantages of having good mechanical strength and resistance to temperature. Furthermore, it is transparent, which is generally preferred by users from an aesthetical point of view.

Thus, at the time of its use, the protective layer is removed to bond on an object (for example a piece of furniture or the like) the first face of the slider pad which is provided with the adhesive.

Obviously, the choice of the materials of the adhesive and the protective layer are well within the reach of those skilled in the art. These are materials commonly used for manufacturing felt slider pads whose fastening means on the object likely to be moved consists of an adhesive.

In a preferred embodiment of the invention, the second face of the felt element is coated with a layer of a low friction material, preferably about 0.04. This layer enables improving the sliding of the slider pad obtained according to the method of the invention. Advantageously, this layer is bonded on the second face of the felt element.

Advantageously, this layer is made of a plastic material selected from the group consisting of polyethylene (preferably high molecular weight polyethylene), polypropylene, nylon, polytetrafluoroethylene (PTFE), polyoxymethylene and mixtures thereof. Preferably, it is polytetrafluoroethylene (PTFE).

This layer improving the sliding of the slider pad has a thickness which has a very small part of the overall thickness of the slider pad according to the invention. The thickness may be comprised between 30 μm and 1 mm, preferably between 50 μm and 600 μm.

Thus, the slider pad obtained according to the method of the invention does not create noise problems when moving the object such as furniture, because it is essentially composed of a felt material which is known by its properties of absorbing noise.

Thus, the slider pad obtained according to the method of the invention is made of felt and has a first face covered with an adhesive which constitutes the fastening means to the heavy object likely to be moved (for example a piece of furniture such as chair or armchair) and a second face opposite the first face which is intended to be in contact with the surface on which the piece of furniture is moved. Optionally, this second face may be covered with a layer of a low friction material, preferably of about 0.04, in order to improve the sliding of the slider pad.

The felt element can be in different shapes among which are cited:
the roller, advantageously of a thickness comprised between 1 and 7 mm, preferably between 3 and 5 mm;
the plate, advantageously of a thickness comprised between 1 and 7 mm, preferably between 3 and 5 mm.

Within the scope of the present invention, the felt of which is composed the slider pad can be selected from the following materials:
wool,
cellulose,
plastic, particularly from the following polymers:
polypropylene, polyamide, polyethylene terephthalate or mixtures of these polymers.

The cuttings are made in a suitable manner according to the desired shape of the slider pad desired to be obtained at the end of the method. Preferably, it consists of washers of diameter in the order of 10 to 50 mm.

The hot-pressing step is suitably carried out to round off the edges of the second face of the slider pads, or in other words to make this second face of the slider pads convex. This step is advantageously carried out at a temperature comprised between 130° C. and 200° C., for example with a metal tool made of aluminum or any other material having a suitable thermal conductivity to round off the edges of the slider pad. The temperature may be adapted depending on the felt used for manufacturing the slider pads. Of course, this adjustment of the pressing temperature is well within the reach of those skilled in the art.

When the second face of the felt element is coated with a layer of a low friction material, preferably of about 0.04, for example PTFE, the hot-pressing temperature could then be higher than that for a felt slider pad. The temperature could be in the order of 200° C. to 250° C.; which also will have the advantage of reducing the duration of this hot-pressing step. The temperature adjustment, in this embodiment of the invention, is also within the reach of those skilled in the art.

Thus, within the scope of the present invention, the hot-pressing step is carried out at a temperature which may be comprised between 130° C. and 250° C.

The fact that the slider pads have a second convex face avoids their clinging to tile joints or any other asperity of the floor when moving the object such as a piece of furniture. In other words, this improves the slide of the slider pad, and this while limiting the forces applied on the felt during the passage by these asperities. Consequently, these rounded edges contribute to:
increase the service life of the slider pads which are not damaged by clinging to the tile joints, and also
prevent the slider pads from peeling off from the object on which they have been bonded (for example a chair or an armchair).

Finally, the slice of the slider pads is often the part of these pads which tends to get clogged the most by picking up dust. Rounding off the edges of the slider pads by hot-pressing has also the advantage of limiting the accumulation of dust on their slice.

In one embodiment of the invention, the steps of cutting and hot-pressing are carried out simultaneously in a same tool, for example in a tool having both cutting blades and concave surfaces made of a material having a suitable thermal conductivity (for example aluminum) to perform cuttings and to round off the edges of parts, and this at high temperatures, namely up to temperatures about 250° C.

In one embodiment of the invention, cuttings called total cuttings are carried out, namely the cuttings through the entire thickness of the felt element. In other words, the felt, the adhesive and the protective layer are cut simultaneously so as to obtain slider pads in the form of individual parts.

In another preferred embodiment of the invention, cuttings called kiss cuttings are carried out, namely the cuttings only in the thickness of the felt and of the adhesive of the felt element. In other words, the protective layer is not cut.

When performing kiss-cuttings, the method according to the invention further comprises a trimming step, so as to remove the surplus material from the felt element which is, let us recall, provided with adhesive on its first face. Thus, there is obtained a plurality of slider pads which are fastened by means of the adhesive on the protective layer.

The trimming step can be carried out prior to or after the hot-pressing step.

Advantageously, when performing kiss cuttings, a guillotining step of the protective layer is carried out so as to obtain a plurality of protective layer plates on which are disposed the slider pads, namely a limited number of slider pads, for example a dozen of slider pads. The guillotining step is well within the reach of those skilled in the art. It is often carried out depending on commercial imperatives of presentation and storage of the slider pads.

The guillotining can be carried out:
after the trimming and prior to the hot-pressing step, or
after the trimming, when trimming has been consecutively carried out at the hot-pressing step, or
after the hot-pressing which has been consecutively carried out at the trimming.

In one embodiment of the method according to the invention, the hot-pressing step is performed prior to the step during which the plurality of cuttings is carried out.

The method for manufacturing slider pads according to the invention is very economical and simple to implement. Furthermore, in one of its embodiments, the method has the advantage of directly obtaining slider pads disposed on protective layer plates which are ready to be put in shelves in the stores, possibly after a final packaging step. In other words, there is obtained, at the end of the method according to the invention, slider pads ready for marketing, without the need of additional packaging steps (costly and sometimes complex) of this product.

1. A method for manufacturing a slider pad with rounded edges which comprises the following steps:
providing at least one felt element which has :
a first face covered with an adhesive, said adhesive being coated with a protective layer and
a second face opposite to the first face ;
performing in the felt element a plurality of cuttings whose shape is suitable for obtaining a plurality of slider pads each having a first face covered with the adhesive coated with the protective layer and a second face opposite to this first face;
hot-pressing the second face of each of the slider pads obtained at the step of cuttings so as to make said second face of each of the slider pads convex.

2. The manufacturing method according to claim 1, wherein the second face of the felt element is coated with a layer of a low friction material of about 0.04.

3. The manufacturing method according to claim 2, wherein the low friction material is polytetrafluoroethylene.

4. The manufacturing method according to claim 1, wherein the step of hot-pressing is carried out at a temperature comprised between 130° C. and 250° C.

5. The manufacturing method according to claim 1, wherein the steps of cuttings and hot-pressing are carried out simultaneously.

6. The manufacturing method according to claim 1, wherein it consists in performing cuttings in the entire thickness of the felt element.

7. The manufacturing method according to claim 1, wherein it consists in performing cuttings only in the thickness of the felt and the adhesive of the felt element and that the method further comprises a trimming step carried out prior to or after the hot-pressing step.

8. The manufacturing method according to claim 7, wherein it consists in carrying out a step of guillotining the protective layer so as to obtain a plurality of plates of protective layer on which the slider pads are disposed.

9. The manufacturing method according to claim 8, wherein the guillotining is carried out:
after the trimming and prior to the hot-pressing step, or
after the trimming, when trimming has been carried out consecutively to the hot-pressing step, or
after the hot-pressing which has been carried out consecutively to the trimming.
